(19) United States
(12) Patent Application Publication
(10) Pub. No.: US 2010/0258637 A1
(43) Pub. Date: Oct. 14, 2010

(54) BANK CARD WITH A USER ACTUATABLE SWITCH

(75) Inventors: François Droz, Corcelles (CH); Philippe Guillaud, Los Angeles, CA (US); Cyril Lalo, Los Angeles, CA (US)

Correspondence Address: GRIFFIN & SZIPL, PC, SUITE PH-1, 2300 NINTH STREET, SOUTH, ARLINGTON, VA, 22204, US

(73) Assignee: NAGRAID SECURITY SA, Le Cret-du-Locle (CH)

(21) Appl. No.: 12/498,747

(22) Filed: Jul. 7, 2009

(30) Foreign Application Priority Data
Apr. 9, 2009 (EP) 09005230.9

(51) Int. Cl. G06K 19/067

(52) U.S. Cl. 235/492

(57) ABSTRACT

The electronic card (2) includes an electronic unit (6), an electric energy source (10), a switch (12) that can be actuated by a user of the electronic card and an application introduced into said electronic unit. It further includes means for detecting actuation of said switch, which determine whether said actuation corresponds to a pulse whose duration is comprised within a certain predetermined time range or to a series of pulses defining a digital signal with a time profile wherein at least one given parameter has a value comprised within a certain predetermined time range, said application being actuated or the actuation thereof validated when said detection means have detected said pulse or said series of pulses. In particular, the switch is associated with a push-button or an elastically deformable zone (14) of the electronic card.

This application claims priority from European Patent Application No. 09005230.9 filed Sep. 4, 2009, the entire disclosure of which is incorporated herein by reference.

### FIELD OF THE INVENTION

Bank cards with a switch that may have, in a general case, the function of actuating the card circuit and/or a digital display of the card or, in a particular case, the function of starting a given program implemented in the card, particularly a secure identification procedure, are already known. It will be noted that, in several applications, the general case and the particular case can be combined, since actuating the power supply of the electronic circuit incorporated in a card automatically starts a secure identification algorithm in order to perform a certain transaction, particularly a banking transaction.

### BACKGROUND OF THE INVENTION

A bank card is known, in particular from U.S. Pat. No. 5,627,355, which is incorporated herein by reference, that includes a switch actuatable by a sort of push-button or a deformable zone of the card, so that the exertion of pressure in the zone of the card containing the switch starts a specific secure identification algorithm. This card further includes at least one digital display for displaying in series various personal identification numbers, or PIN codes. This card also includes an electronic unit and an electric power source associated with a solar cell arranged on the surface of the card. This type of card can be used in various services, whether for making telephone calls from public telephones, a service for downloading films from the Internet, or accessing a bank or postal account, particularly so as to perform various transactions, such as the payment of bills.

The identification program provided in U.S. Pat. No. 5,627,355 consists in storing a list of PIN codes in the card, generated uniquely for a given client, the same list being stored in the bank's server. Each time the card is actuated by the switch, a new personal code is selected in the list and displayed. This selection generally consists in taking the next unused code from the pre-established list. The user has to enter the code in the machine or computer that transmits it to the server. The server checks that the code is actually the next unused code in the list for the client in question. This is known as a “one time password” or OTP. The importance of maintaining synchronization between the position in the card list and the position in the server's list is thus clear. If codes in the card list are used without being transmitted to the server, particularly when the card is inadvertently actuated, the code transmitted during the next transaction with the server will not match the next unused code in the server's list. U.S. Pat. No. 5,627,355 mentions a method for partially overcoming this problem, via comparison with a code sequence in the server's list so as to detect any loss of synchronization and thus re-establish the match between the two lists. This method can only be limited to a short sequence, particularly for security reasons. Consequently, if several codes are wasted in the card, the system will no longer accept the codes supplied by the client. Then, even if the match is regularly updated, usable codes are wasted and there is thus a smaller number of possible transactions for a given list stored in the card. The card will thus be used up more quickly. Finally, another drawback connected to this problem arises from the fact that inadvertent actuations of the card result in a wasteful increase in the consumption of the electric energy stored in the card.

In general, a first actuation of the switch of a card of the type described above is for initializing the application. Next, each new cycle is started by each new actuation of the switch. The problem connected to inadvertent actuations of the switch and thus of the secure identification program does not only concern the card user, who, for example, places the card in a wallet in his back trouser pocket and who, when sitting down, may sometimes unintentionally actuate the card switch, but also production steps during which pressure is exerted on the card, particularly when outer layers are added by laminating or printing steps. Thus, when the client receives a new card, it may have already consumed a certain number of personal identification numbers. If this number is higher than that tolerated by the system that manages the application, the client then receives a defective card which does not work. This situation is evidently detrimental for the service supplier and causes difficulties for clients.

### SUMMARY OF THE INVENTION

It is an object of the present invention to provide an electronic card with a switch that can be actuated by a user and that overcomes the aforementioned problem.

The present invention therefore concerns an electronic card including an electronic unit, an electrical energy source, a switch that can be actuated by the user of the electronic card and an application introduced into said electronic unit, characterized in that it further includes means for detecting actuation of said switch, which determine whether the actuation corresponds to a pulse whose length is comprised within a certain predetermined time range or to a series of pulses defining a digital signal with a time profile, wherein at least one given parameter has a value comprised within a certain predetermined time range, said application being actuated or the actuation being validated when said detection means have detected said pulse or said series of pulses.

According to the invention, at least one determined time parameter of the user actuation signal of the switch is checked to authorize execution of the application or a cycle thereof to validate such execution. It will be noted that this procedure may also be applied to powering some part of the electronic unit and to powering a display so as to limit as far as possible the electrical power consumption of the card. One could thus provide that only a standby circuit is permanently powered, and this circuit is arranged to detect at least a first actuation signal from the switch. One could also provide that the first actuation of the switch, after the card has entered inactive mode, actuates the power supply to one part of or the entire electronic unit which, as soon as it is powered, detects and processes the actuation signal from the switch to determine whether it corresponds to an actuation signal for said application.

Owing to the features of the invention, prolonged pressure on the switch, particularly during laminating in manufacture, can be prevented from causing actuation of the application in question. In the case of a series of pulses, the switch is intelligent, which will rule out any long or short actuation of the switch, when the time profile of the digital signal generated does not match a profile with at least one parameter whose value is comprised within a given time range. By selecting this parameter so as to rule out at least most possible unintentional actuation signals linked to the typical actions or behaviour of a conventional user, one ensures that the application is started essentially only by deliberate actuation by the user.

### BRIEF DESCRIPTION OF THE DRAWINGS

Embodiments of the invention will be described below with reference to drawings, given by way of non-limiting examples, which are annexed to the present description and in which:

FIG. 1 shows schematically the architecture of an electronic card according to the invention;

FIG. 2 shows the time profile of an actuation signal for an integrated application in the electronic card in accordance with a first envisaged variant, and

FIG. 3 shows the time profile of an actuation signal for an integrated application in the electronic card in accordance with a second envisaged variant.

### DETAILED DESCRIPTION OF THE PREFERRED EMBODIMENTS

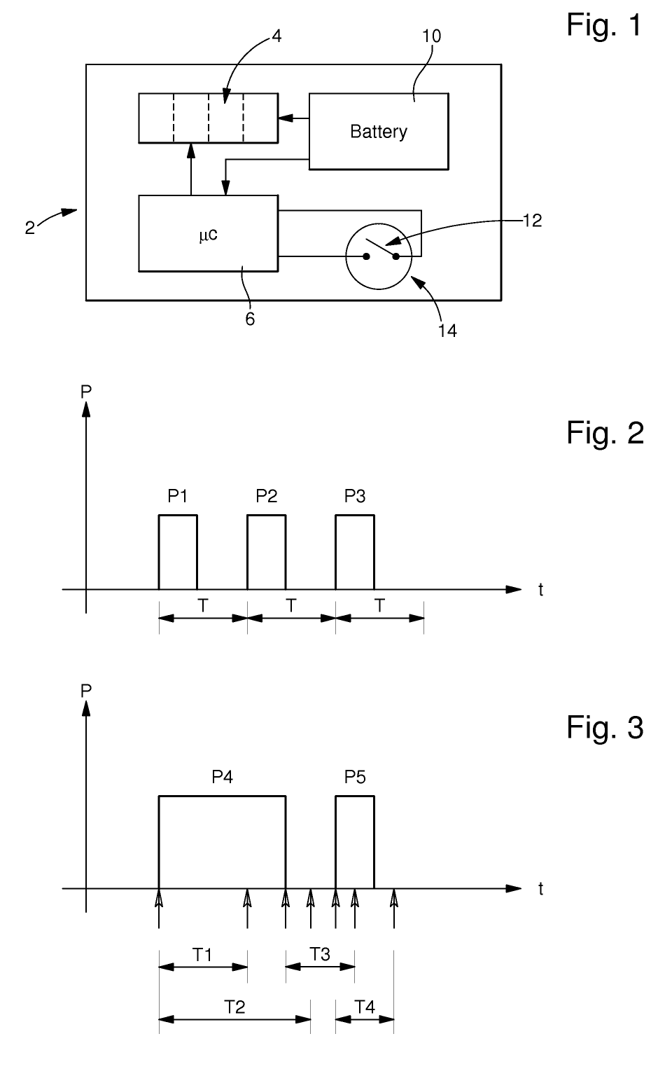

FIG. 1 shows an electronic card 2 including a digital display 4, an electronic unit 6, a battery 10 and a switch 12 that can be actuated by a user of the electronic card. The switch is integrated in the card and associated with a sort of push-button 14 or an elastically deformable zone of the card, and, when pressure is exerted in the deformable zone or on the push-button, the switch is actuated. Actuation of the switch is detected by actuation detection means associated with means for controlling an application introduced into the electronic card. These detection means and control means can themselves be actuated when the start of actuation of the switch is detected, causing at least the detection means to be powered. It will be noted that, in the example of FIG. 1, electronic unit 6 is formed by a microprocessor, which defines the aforementioned detection means and the control means. Other embodiments with electronic circuits respectively dedicated to these detection means and control means can be provided within the scope of the present invention.

In particular, the application considered consists in a secure card user identification program with a system connected to the server of a service supplier. The program generates or reads personal one time passwords (OTP).

The detection means are arranged for detecting actuation of said switch 12, particularly via the closure thereof, and for determining whether the actuation corresponds to a pulse whose length is comprised within a certain predetermined time range or to a series of pulses defining a digital signal with a time profile, wherein at least one given parameter has a value comprised within a certain predetermined time range. If this is the case, the application is actuated or its actuation is validated by the control means. In particular, the application displays the personal identification code to be used for a next transaction. The application can only perform this display after detection of a signal from the user via the switch that corresponds to a valid signal, or it can start the application as soon as the switch starts to be actuated and then display the code for the user, the code being valid (i.e. considered as used) only if said valid signal is eventually detected. If said valid signal is not detected, the display means are rapidly deactivated and the displayed code is considered as not used. The display means are preferably actuated simultaneously with actuation of said application. They remain in an active state for a certain period allowing the user to introduce the code displayed in the system associated with the card prior to being de-actuated again.

According to a first embodiment of the invention, the series of pulses required to actuate the electronic card, in particular an application implemented in the latter, consists of at least two pulses occurring in successive time periods of a given duration T. In the variant shown in FIG. 2, three pulses P1, P2, P3 are provided. In another embodiment, the period detected may be the time interval between the three pulses, this time interval must be less than a given duration.

According to another embodiment, pulses of variable length are provided. In the variant shown in FIG. 3, a relatively long pulse, followed by a shorter pulse is provided. Various parameters can be defined to characterize the series of pulses that generate actuation of the electronic card application concerned. By way of example, four parameters can be defined to define a certain series of two pulses. This example provides that the length of the first pulse P4 is comprised between values T1 and T2. The time period between the two pulses must be less than T3 and the length of second pulse P5 must be less than T4. One could also require the time period between the two pulses to be greater than a certain other time period, which takes account of a minimum possible time period for a user between two successive applications of pressure while releasing pressure in between.

In the case of a single pulse, a minimum and maximum time period will preferably be defined for the pulse.

Other variants may be selected by those skilled in the art within the scope of the present invention.

What is claimed is:

1. An electronic card including an electronic unit, an electric energy source, a switch that can be actuated by a user of the electronic card and an application introduced into said electronic unit, wherein it further includes means for detecting actuation of said switch, which determine whether said actuation corresponds to a pulse whose length is comprised within a certain predetermined time range or to a series of pulses defining a digital signal with a time profile wherein at least one given parameter has a value comprised within a certain predetermined time range, said application being actuated or the actuation thereof validated when said detection means have detected said pulse or said series of pulses.

2. The electronic card according to claim 1, wherein said switch is associated with a push-button or with an elastically deformable zone of the electronic card.

3. The electronic card according to claim 1, further comprising a digital display, wherein said application is a personal identification program using personal one time passwords, which are displayed by said digital display.

4. The electronic card according to claim 1, wherein said given parameter corresponds to a maximum time period for at least one pulse of said series of pulses.

5. The electronic card according to claim 1, wherein each pulse provided must occur within successive time periods of predefined length.

6. The electronic card according to claim 1, wherein the time interval between two successive pulses is provided to be less than a certain predetermined time period.

7. The electronic card according to claim 1, wherein the time interval between two successive pulses is provided to be greater than a certain predetermined time period.

8. The electronic card according to claim 1, wherein said series of pulses includes at least two pulses of different lengths.
